(19) United States
(12) Patent Application Publication
(10) Pub. No.: US 2017/0358197 A1
(43) Pub. Date: Dec. 14, 2017

(54) REMOTE FINDER

(71) Applicant: Jason Hanley, Maysville, GA (US)

(72) Inventor: Jason Hanley, Maysville, GA (US)

(21) Appl. No.: 15/180,612

(22) Filed: Jun. 13, 2016

(51) Int. Cl. G08B 21/24; G08B 3/10; G08B 5/36

(52) U.S. Cl. CPC G08B 21/24; G08B 5/36; G08B 3/10

(57) ABSTRACT

The present invention relates to a miniature tracking device to be placed in a peripheral device for identifying the location of the peripheral like a remote controlling device. Further, the electronic peripheral locator system, furthermore, the system comprises of a transceiver for transmitting and receiving signals, a computing based means to send instructions to the transceiver from an external electronic device to locate an electronic peripheral, a power source to power the electronic peripheral locator system and a housing to hold the transceiver and the power source.

### CROSS REFERENCE TO RELATED APPLICATIONS

Not applicable

### FEDERALLY SPONSORED RESEARCH AND DEVELOPMENT

Not applicable.

### FIELD OF THE INVENTION

The present invention relates to locating devices. More particularly, the present invention relates to locating devices for finding misplaced or lost keys, remote controls, wallets, etc.

### BACKGROUND OF THE INVENTION

A number of devices exist to provide location information indicating the location of a device. Different methods may be used by such systems to determine a device's location. For example, positioning methods can determine a location of a target device from measurements by the target device of known external signal sources, such as global positioning system (GPS) satellites or wireless communication network base stations. These measurements may enable the current absolute location of the target device to be obtained, for example its precise latitude, longitude and altitude.

It is well known that the remote controls are frequently misplaced or lost within a household, as many users tend to use the remote and place it in different locations within a room or even within an entire household when moving from room to room. Such devices are convenience articles that allow remote access and control over a television or similar electronic accessory while seated and positioned a given distance away. Misplacing such articles, while common, is a very frustrating occurrence that can lead to reduced television functionality and user control thereover, as most modern televisions include sophisticated menus and features and minimal physical interfaces for control thereof. To find lost and misplaced remote controls, it is sometimes required to inspect seat cushions and search the household, which is both time consuming and inefficient. Furthermore, lost remotes that go unrecovered create an issue of finding a suitable replacement, wherein generic remote controls may lack the appropriate interface or suitable means of communicating with all of the television features that are inherent in the original remote. The present invention is therefore submitted as an improved device and system of locating and recovering such an article after being misplaced, wherein the accompanying television or television accessory includes three modes of interacting with the remote and initiating a locating signal therefrom.

Few of the existing peripheral locator are illustrated in U.S. Pat. No. 6,573,832 B1, U.S. Pat. No. 6,535,125 B2 and U.S. Pat. No. 7,436,460 B2.

U.S. Pat. No. 6,573,832 B1 to Lyne Fugere-Ramirez shows a remote control finder or locating device for finding lost personal items, such as keys, a television/VCR remote control, a pager, a cellular phone or eyeglasses. The remote finder sends a radio signal to a selected one of a plurality of button-shaped receivers that emits an audible beeping noise upon activation of the appropriate radio signal. The receiver attaches to the back of any personal item by a sticker. The remote control transmitter has individually numbered buttons which correspond to the item the user wishes to locate. The remote control transmitter fits into a wall-mounted bracket when not in use. In case the remote control transmitter, itself, is lost, a button located on the mounting bracket sends out a signal which activates the remote control transmitter to emit a beeping sound and so assists in locating the finder.

U.S. Pat. No. 6,535,125 B2 to Sam W. Trivett shows a remote control locator system that can be retro-fitted to any existing remote control device in a straightforward manner. The remote control locator system comprises a sending unit and a receiving unit. The sending unit includes a transmitter residing in a sending unit housing and an activation mechanism coupled to the transmitter to send a locator signal when the activation mechanism is activated by a user. The receiving unit includes a receiver residing in a receiving unit housing to receive the locator signal and to emit an audible sound when the receiver receives the locator signal.

U.S. Pat. No. 7,436,460 B2 to Jordan Willard Hawkwood Glazier shows an embodiment of the present invention for the first time includes a television and a remote control for the television, with an activator installed in the television at the time of manufacture, and with a locator signal generator, which may be a beeper, a flashing light, or other device, installed in the remote control at the time of manufacture. Using the activator in the television will activate the locator signal generator in the remote control. The resulting signal, which may be a sound, or a flashing light, or both, or another signal, enables the user to locate the remote control. The activator wirelessly communicates to the signal generator to activate the signal generator.

Further, none of this prior art suggests the present inventive combination of component elements arranged and configured for the efficient solution of this problem as disclosed and claimed herein. Prior devices do not provide the benefits of the present invention which achieves its intended purposes, objectives and advantages over the prior art devices through a new, useful and unobvious combination of component elements, through no increase in the number of functioning parts, at a minimum cost and through the utilization of only readily available materials and conventional components.

### SUMMARY OF THE INVENTION

The primary objective of the invention is to provide a miniature tracking device to be placed in a peripheral device for identifying the location of the peripheral like a remote controlling device.

In one intent, the invention provides an electronic peripheral locator system, furthermore, the system comprises of a transceiver for transmitting and receiving signals, a computing based means to send instructions to the transceiver from an external electronic device to locate an electronic peripheral, a power source to power the electronic peripheral locator system and a housing to hold the transceiver and the power source.

In another intent, the invention provides a computer implemented method for locating an electronic peripheral, furthermore the method comprises of a means for transceiving signal from a transceiver for tracking and locating the electronic peripheral and a computing based means implemented in the external electronic device to send instruction to said transceiver to identify location of the electronic peripheral. Moreover the transceiver is capable of communicating and executing the instruction sent from an external electronic device to locate the electronic peripheral.

In another intent, the transceiver of the electronic peripheral locator system comprises of a tracker module for locating an electronic peripheral and an identification module to isolate a location of the electronic peripheral.

In another intent, the tracker module in the invention capable of receiving instruction sent from the computing based means and executing the instruction sent from the external electronic device and the identification module uses an audio visual unit to locate the electronic peripheral.

In another intent, the electronic peripheral locator system of the invention, the audio visual unit for identification of the location of the electronic peripheral comprises of an audio output device and an illuminating device.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows the exploded view of the electronic peripheral locator in an embodiment of the present invention;

FIG. 2 shows the perspective view of the external electronic device with a graphical user interface to initiate the locator system in an embodiment of the invention; and

FIG. 3 shows the perspective view of the electronic peripheral locator system in an embodiment of the present invention with its components.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention can be implemented on any communication device that has hardware components that can perform wireless and wired communication such as (but not limited to)—multi-purpose pocket computers, personal multimedia devices, etc.

The various devices on which the applications that implement the present invention run may use one or more processors with different instruction-sets, architectures, clock-speeds, etc. and a memory that may include high speed random access memory and may include non-volatile memory such as one or more magnetic disk storage devices, flash memory devices and other kinds of solid state memory devices.

The various applications that can implement the present invention run on electronic devices that may use at least one physical user interface device that provide the means of control and navigation within the operating system and applications that run on the devices include (but not limited to) touch-pads, touch screens, mouse and gesture recognition means.

Display means used by these devices may use LCD (liquid crystal display) technology, LED (light Emitting Diode) technology, CRT (Cathode ray tube) technology, or LPD (light emitting polymer) technology or any other display technologies. Various realizations of graphics display circuitry that implement a Graphics Processing Unit (GPU) are used to achieve video interface between user and these electronic devices.

Connectivity of these devices with networks such as the internet, an intranet and/or wireless network such as cellular telephone network, a wired or wireless local area network (LAN) and/or metropolitan area network (MAN) and/or WAN (wide area network) and other wireless communication is achieved by use of a plurality of communication standards, protocols and technologies like Bluetooth, Wireless Fidelity (Wi-Fi) and/or any other suitable communication protocol, including communication protocols not yet developed as of the filing date of this document.

The present invention may be implemented on applications that run on a single or variety of operating system platforms including but not limited to OS X, WINDOWS, UNIX, IOS, ANDROID, SYMBIAN, LINUX, or embedded operating systems such as VxWorks.

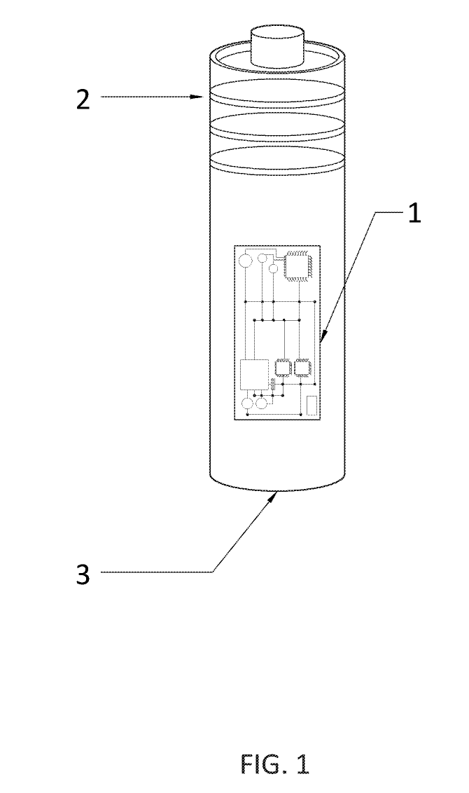

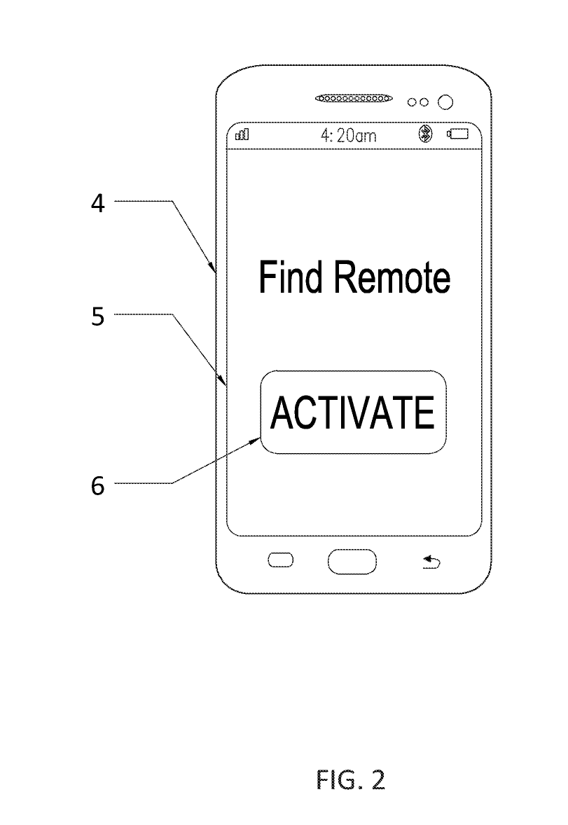

Referring now to the drawings, wherein like reference characters designate identical, or corresponding parts throughout the figures, and in particular FIGS. 1, 2 & 3 show various embodiments of the electronic peripheral locator system in accordance with the present invention.

FIG. 1 shows the electronic peripheral locator in exploded view, including the transceiver 01 to provide signal communication, the power source 02 to power the transceiver 01 and the housing 03 to provide a casing to the transceiver 01 and the power source 02.

FIG. 2 shows the prospective view of the external electronic device used in the invention, including the external electronic device 04, the display 05 used in the external electronic device 04, the graphical user interface 06 for the displaying the social computing based means over the display 05 used in the external electronic device 04 to initiate the locating system.

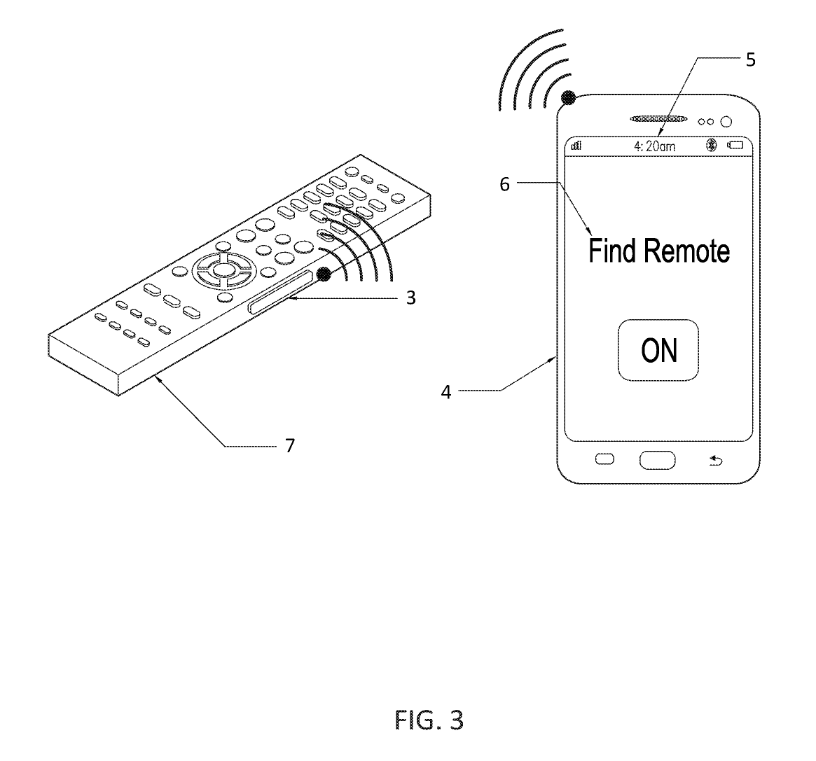

FIG. 3 shows the prospective view of the electronic peripheral locator system in an embodiment of the present invention, including the electronic peripheral 07 with the housing 03 holding the transceiver 01 to provide signal communication, the power source 02 to power the transceiver 01 and the graphical user interface 06 for the displaying the social computing based means over the display 05 used in the external electronic device 04 by a user to initiate the locating of the electronic peripheral 07 using the electronic peripheral locator system.

The present invention generally provides an electronic peripheral locator system, system comprises of a transceiver 01 for transmitting and receiving signals, a computing based means displayed over the display 06 of the external electronic device 04 to send instructions to the transceiver 01 to locate an electronic peripheral 07, a power source 02 to power the electronic peripheral locator system and a housing 03 to hold the transceiver 01 and the power source 02.

In an embodiment, the present invention provides a computer implemented method for locating an electronic peripheral 07, the method comprises of a means for transceiving signal from a transceiver 01 for tracking and locating the electronic peripheral 07 and a computing based means implemented in the external electronic device 04 to send instruction to said transceiver 01 to identify location of the electronic peripheral 07. Moreover the transceiver 01 is capable of communicating and executing the instruction sent from an external electronic device 04 to locate the electronic peripheral 07.

In another embodiments of the present invention the transceiver 01 of the electronic peripheral locator system comprises of a tracker module for locating the electronic peripheral 07 and an identification module to isolate a location of the electronic peripheral 07. Further the tracker module in the invention capable of receiving instruction sent from the computing based means and executing the instruction sent from the external electronic device 04 and the identification module uses an audio visual unit to locate the electronic peripheral. Furthermore, in the electronic peripheral locator system of the invention the audio visual unit for identification of the location of the electronic peripheral 07 comprises of an audio output device and an illuminating device.

In one preferred embodiment of the present invention the audio output device and the illuminating device in the transceiver 01 used to locate electronic peripheral 07 is speaker enabled to create an alarming sound and create an electroluminescent alarming light. Moreover the illuminating device further comprises of at least one flashing light source and the computing based means displayed over the display 06 of the external electronic device 04 is application software. Furthermore the system is connected to an internal power source. The power source 02 used in the system is a source like a rechargeable, also the system is connected to the power source of the electronic peripheral 07, the electronic peripheral locator system is attached to.

In various embodiments of the present invention the housing is made of material selected from group of metal alloy, plastic and combination thereof. The illuminating device is selected from the group of light emitting diode, cathode ray tube, laser or combination thereof. Moreover, the external electronic device is selected from group of smart phone, tablet computer, PDA.

It is to be understood that the above description is intended to be illustrative, and not restrictive. For example, the above-discussed embodiments may be used in combination with each other. Many other embodiments will be apparent to those of skill in the art upon reviewing the above description.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. An electronic peripheral locator system, said system comprising:
a transceiver for transmitting and receiving signals;
a computing based means to send instruction to said transceiver from an external electronic device to locate an electronic peripheral;
a power source to power said electronic peripheral locator system ; and
a housing to hold said transceiver and said power source.

2. The electronic peripheral locator system as set forth in claim 1, wherein said transceiver further comprise of:
a tracker module for locating an electronic peripheral, wherein said tracker module capable of receiving instruction sent from said computing based means and executing said instruction sent from said external electronic device; and
an identification module to isolate a location of said electronic peripheral, wherein identification of said location using an audio visual unit.

3. The electronic peripheral locator system as set forth in claim 2, wherein said audio visual unit for identification of said location of said electronic peripheral further comprises of:
an audio output device; and
an illuminating device.

4. The electronic peripheral locator system as set forth in claim 3, wherein said audio output device is enabled to create an alarming sound.

5. The electronic peripheral locator system as set forth in claim 3, wherein said audio output device is a speaker.

6. The electronic peripheral locator system as set forth in claim 3, wherein said illuminating device is enabled to create an electroluminescent alarming light.

7. The electronic peripheral locator system as set forth in claim 3, wherein said illuminating device further comprises of at least one light source.

8. The electronic peripheral locator system as set forth in claim 3, wherein said illuminating device is a flashing light.

9. The electronic peripheral locator system as set forth in claim 3, wherein said illuminating device is selected from the group of light emitting diode, cathode ray tube, laser or combination thereof.

10. The electronic peripheral locator system as set forth in claim 1, wherein said computing based means is an application software.

11. The electronic peripheral locator system as set forth in claim 1, wherein said external electronic device is selected from group of smart phone, tablet computer, PDA.

12. The electronic peripheral locator system as set forth in claim 1, wherein said system is connected to an internal power source.

13. The electronic peripheral locator system as set forth in claim 1, wherein said power source is a power source of said electronic peripheral said electronic peripheral locator system is attached to.

14. The electronic peripheral locator system as set forth in claim 1, wherein said housing is made of material selected from group of metal alloy, plastic and combination thereof.

15. A computer implemented method for locating a electronic peripheral, said method comprising:
a means for transceiving signal from a transceiver for tracking and locating said electronic peripheral, wherein said transceiver is capable of communicating and executing instruction sent from an external electronic device to locate said electronic peripheral; and
a computing based means implemented in said external electronic device to send instruction to said transceiver to identify location of said electronic peripheral.

16. The computer implemented method for locating a electronic peripheral as set forth in claim 15, wherein said method further comprises:
an audio output mean; and
an illuminating means.

17. The computer implemented method for locating an electronic peripheral as set forth in claim 16, wherein said audio output means is enabled to create an alarming sound.

18. The computer implemented method for locating an electronic peripheral as set forth in claim 16, wherein said audio output means is a speaker.

19. The computer implemented method for locating an electronic peripheral as set forth in claim 16, wherein said illuminating means is enabled to create an electroluminescent alarming light.

20. The computer implemented method for locating an electronic peripheral as set forth in claim 16, wherein said illuminating means further comprises of at least one light source.

21. The computer implemented method for locating an electronic peripheral as set forth in claim 16, wherein said illuminating means is a flashing light.

22. The computer implemented method for locating an electronic peripheral as set forth in claim 16, wherein said illuminating means is selected from the group of light emitting diode, cathode ray tube, laser or combination thereof.

23. The computer implemented method for locating an electronic peripheral as set forth in claim 15, wherein said computing based means is an application software.

24. The computer implemented method for locating an electronic peripheral as set forth in claim 15, wherein said external electronic device is selected from group of smart phone, tablet computer, PDA.

25. The computer implemented method for locating an electronic peripheral as set forth in claim 15, wherein said system is connected to an internal power source.

26. The computer implemented method for locating an electronic peripheral as set forth in claim 15, wherein said power source is a power source of said electronic peripheral said electronic peripheral locator system is attached to.

27. The computer implemented method for locating an electronic peripheral as set forth in claim 15, wherein said transceiver and said power source in cased into a housing.

28. The computer implemented method for locating a electronic peripheral as set forth in claim 26, wherein said housing is made of material selected from group of metal alloy, plastic and combination thereof.
